(19) United States
(12) Patent Application Publication
(10) Pub. No.: US 2026/0099316 A1
(43) Pub. Date: Apr. 9, 2026

(54) METHOD OF UPDATING INTRUSION DETECTION POLICY CONSIDERING DRIVING SITUATION OF VEHICLE AND DEVICE FOR PERFORMING THE SAME

(71) Applicants: Hyundai Motor Company, Seoul (KR); Kia Corporation, Seoul (KR)

(72) Inventors: Jiyong HAN, Hwaseong-Si (KR); Hayoung LEE, Hwaseong-Si (KR); Sujin KWON, Hwaseong-Si (KR)

(21) Appl. No.: 19/223,298

(22) Filed: May 30, 2025

(30) Foreign Application Priority Data
Oct. 8, 2024 (KR) 10-2024-0136921

(51) Int. Cl. G06F 8/65

(52) U.S. Cl. CPC G06F 8/65

(57) ABSTRACT

A method performed by an apparatus of a vehicle is introduced. The method may comprise transmitting, based on a power state of the vehicle being turned on, version information of an intrusion detection policy for the vehicle and vehicle information of the vehicle to a server, wherein the version information and the vehicle information are stored in at least one storage of the vehicle. The method may further comprise receiving, from the server, a response to the transmitting, identifying, based on a latest version of the intrusion detection policy received via the response, a gear state of the vehicle, determining, based on the gear state of the vehicle being a parking state, whether the power state of the vehicle is turned on, installing, based on a determination that the power state of the vehicle is turned on, the latest version of the intrusion detection policy on the vehicle, and controlling, based on the latest version of the intrusion detection policy installed on the vehicle, operations of the vehicle.

### CROSS-REFERENCE TO RELATED APPLICATION

This application claims the benefit of priority to Korean Patent Application No. 10-2024-0136921, filed in the Korean Intellectual Property Office on Oct. 8, 2024, the disclosure of which is incorporated herein by reference in its entirety.

### TECHNICAL FIELD

The present disclosure relates to a method of updating a security configuration (e.g., an intrusion detection policy) considering a driving (e.g., autonomous driving) state of a vehicle and a device for performing the same, and more specifically, to a method of updating an intrusion detection policy by determining a driving situation of a vehicle for the safety of a vehicle and a passenger, and a device for performing the same.

### BACKGROUND

The matters described in this Background section are only for the enhancement of understanding of the background of the disclosure, and should not be taken as acknowledgment that they correspond to prior art already known to those skilled in the art.

An intrusion detection system (IDS) and an intrusion protection system (IPS) may be used for network security. The IDS may monitor whether known malicious activity, suspicious activity, or security policy violation occurs in network traffic and devices, and the IPS may monitor potential threat in network traffic, alert a security team, and automatically block the potential threat, that is, by terminating dangerous connection, removing malicious content, or triggering other security devices. The IPS may be referred to as an intrusion prevention system (IPS). The IDS and the IPS may be separate systems, but may also be a single system, that is, an intrusion detection and protection system (IDPS).

As a plurality of electronic control units may be included in a vehicle and various functions may be implemented, the vehicle may also be connected to the Internet. Therefore, cyberattacks on vehicles have increased, and attackers are continuously searching for new vulnerabilities in the vehicles. Therefore, a system for detecting and preventing an intrusion into an in-vehicle network is considered. In addition, since new intrusions are found over time, alternatives that may reflect this are also considered.

### SUMMARY

According to the present disclosure, a method performed by an apparatus of a vehicle, the method may comprise transmitting, based on a power state of the vehicle being turned on, version information of an intrusion detection configuration for the vehicle and vehicle information of the vehicle to a server, wherein the version information and the vehicle information are stored in at least one storage of the vehicle, receiving, from the server, a response to the transmitting, identifying, based on a latest version of the intrusion detection configuration received via the response, a gear state of the vehicle, determining, based on the gear state of the vehicle being a parking state, whether the power state of the vehicle is turned on, installing, based on a determination that the power state of the vehicle is turned on, the latest version of the intrusion detection configuration on the vehicle, and controlling, based on the latest version of the intrusion detection configuration installed on the vehicle, operations of the vehicle.

The method, wherein the vehicle information may comprise information indicating a current driving state of the vehicle, wherein the latest version of the intrusion detection configuration may comprise at least one intrusion detection configuration associated with autonomous driving control of the vehicle, and wherein the controlling the operations of the vehicle may comprise controlling, based on the latest version of the intrusion detection configuration installed on the vehicle, autonomous driving operations of the vehicle.

The method, wherein the information indicating the current driving state of the vehicle may comprise at least one of the power state of the vehicle or the gear state of the vehicle, and wherein the power state of the vehicle may comprise an ignition (IG) state of the vehicle.

The method may further comprise detecting an intrusion into the vehicle using an intrusion detection configuration corresponding to a version indicated by the version information that has been transmitted to the server.

The method may further comprise applying, based on the gear state of the vehicle being the parking state and the power state of the vehicle being turned off, the installed latest version of the intrusion detection configuration to a security system of the vehicle, wherein the controlling the operations of the vehicle may comprise, after the applying the installed latest version of the intrusion detection configuration to the security system of the vehicle, controlling, based on the applied latest version of the intrusion detection configuration, the operations of the vehicle.

The method may further comprise deleting an intrusion detection configuration corresponding to a version indicated by the version information that has been transmitted to the server.

The method may further comprise downloading, based on the gear state of the vehicle being a driving state, the latest version of the intrusion detection configuration, wherein the latest version of the intrusion detection configuration is included in the received response.

The method may further comprise detecting an intrusion into the vehicle using an intrusion detection configuration corresponding to a version indicated by the version information that has been transmitted to the server.

The method, wherein the latest version of the intrusion detection configuration is encrypted and included in the received response, and wherein the latest version of the intrusion detection configuration may comprise a digital signature.

According to the present disclosure, an electronic device of a vehicle, the electronic device may comprise a processor, a communication circuit, and a memory storing at least one instruction that, when executed by the processor, is configured to cause the electronic device to transmit, via the communication circuit and based on a power state of the vehicle being turned on, version information of an intrusion detection configuration for the vehicle and vehicle information of the vehicle to a server, wherein the version information and the vehicle information are stored in at least one storage of the vehicle, receive, from the server via the communication circuit, a response to the transmission, identify, based on a latest version of the intrusion detection configuration received via the response, a gear state of the vehicle, determine, based on the gear state of the vehicle being a parking state, whether the power state of the vehicle is turned on, install, based on a determination that the power state of the vehicle is turned on, the latest version of the intrusion detection configuration on the vehicle, and control, based on the latest version of the intrusion detection configuration installed on the vehicle, operations of the vehicle.

The electronic device wherein the vehicle information may comprise information indicating a current driving state of the vehicle, wherein the latest version of the intrusion detection configuration may comprise at least one intrusion detection configuration associated with autonomous driving control of the vehicle, and wherein the at least one instruction, when executed by the processor, is configured to cause the electronic device to control the operations of the vehicle by controlling, based on the latest version of the intrusion detection configuration installed on the vehicle, autonomous driving operations of the vehicle.

The electronic device wherein the information indicating the current driving state of the vehicle may comprise at least one of the power state of the vehicle or the gear state of the vehicle, and wherein the power state of the vehicle may comprise an ignition (IG) state of the vehicle.

The electronic device wherein the at least one instruction, when executed by the processor, is further configured to cause the electronic device to detect an intrusion into the vehicle using an intrusion detection configuration corresponding to a version indicated by the version information that has been transmitted to the server.

The electronic device wherein the at least one instruction, when executed by the processor, is further configured to cause the electronic device to apply, based on the gear state of the vehicle being the parking state and the power state of the vehicle being turned off, the installed latest version of the intrusion detection configuration to a security system of the vehicle, wherein the at least one instruction, when executed by the processor, is configured to cause the electronic device to control the operations of the vehicle by, after the applying the installed latest version of the intrusion detection configuration to the security system of the vehicle, controlling, based on the applied latest version of the intrusion detection configuration, the operations of the vehicle.

The electronic device wherein the at least one instruction, when executed by the processor, is further configured to cause the electronic device to delete an intrusion detection configuration corresponding to a version indicated by the version information that has been transmitted to the server.

The electronic device wherein the at least one instruction, when executed by the processor, is further configured to cause the electronic device to download, based on the gear state of the vehicle being a driving state, the latest version of the intrusion detection configuration, wherein the latest version of the intrusion detection configuration is included in the received response.

The electronic device wherein the at least one instruction, when executed by the processor, is further configured to cause the electronic device to detect an intrusion into the vehicle using an intrusion detection configuration corresponding to a version indicated by the version information that has been transmitted to the server.

The electronic device wherein the latest version of the intrusion detection configuration is encrypted and included in the received response, and wherein the latest version of the intrusion detection configuration may comprise a digital signature.

According to the present disclosure, a method performed by an apparatus of a vehicle, the method may comprise transmitting, via a wireless transceiver of the vehicle and based on a power state of the vehicle being turned on, version information of a security configuration of the vehicle and vehicle information of the vehicle, receiving, via the wireless transceiver, a response to the transmitting, wherein the response may comprise a latest version of the security configuration, determining, based on the latest version of the security configuration being newer than a version indicated by the version information, a gear state of the vehicle, storing, based on the gear state of the vehicle not being a parking state, the latest version of the security configuration, installing, the gear state being transitioned to the parking state, the latest version of the security configuration on the vehicle, and controlling, based on the latest version of the security configuration installed on the vehicle, operations of the vehicle.

The method, wherein the vehicle information may comprise information indicating a current driving state of the vehicle, wherein the latest version of the security configuration may comprise at least one security configuration associated with autonomous driving control of the vehicle, and wherein the controlling the operations of the vehicle may comprise controlling, based on the latest version of the security configuration installed on the vehicle, autonomous driving operations of the vehicle.

### BRIEF DESCRIPTION OF THE DRAWINGS

The above and other objects, features and advantages of the present disclosure will become more apparent to those of ordinary skill in the art by describing examples thereof in detail with reference to the accompanying drawings, in which:

FIG. 1 shows an example in which an intrusion may be caused by a device outside a vehicle in an entire system, in which an in-vehicle electronic device capable of detecting and preventing an intrusion is connected to a server, according to one example of the present disclosure;

FIG. 2 shows an example of updating an intrusion detection policy by the in-vehicle electronic device through communication with the server according to one example of the present disclosure;

FIG. 3 shows an example of updating an intrusion detection policy considering a driving situation of a vehicle by the in-vehicle electronic device according to one example of the present disclosure; and

FIG. 4 shows an example of an electronic device that updates the intrusion detection policy considering the driving situation of the vehicle, which may be included in the vehicle, according to one example of the present disclosure.

### DETAILED DESCRIPTION

Hereinafter, examples of the present disclosure will be described in detail with reference to the accompanying drawings.

However, the technical spirit of the present disclosure is not limited to some of the described examples, but may be implemented in various different forms, and one or more of the components among the examples may be used by being selectively coupled or substituted without departing from the scope of the technical spirit of the present disclosure.

In addition, terms (including technical and scientific terms) used in examples of the present disclosure may be construed as meaning that may be generally understood by those skilled in the art to which the present disclosure pertains unless explicitly specifically defined and described, and the meanings of the commonly used terms, such as terms defined in a dictionary, may be construed in consideration of contextual meanings of related technologies.

In addition, the terms used in the examples of the present disclosure are for describing the examples and are not intended to limit the present disclosure.

In the specification, a singular form may include a plural form unless otherwise specified in the phrase, and when described as “at least one (or one or more) of A, B, and C,” one or more among all possible combinations of A, B, and C may be included.

For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as “A, B, and C”, “A, B, or C”, “at least one of A, B, and C”, “at least one of A, B, or C”, etc. as used herein may mean each listed item or all possible combinations of the listed items. For example, “at least one of A or B” may refer to (1) at least one A; (2) at least one B; or (3) at least one A and at least one B.

In addition, terms such as first, second, A, B, (a), and (b) may be used to describe components of the examples of the present disclosure.

These terms are only for the purpose of distinguishing one component from another component, and the nature, sequence, order, or the like of the corresponding components is not limited by these terms.

In addition, when a first component is described as being “connected,” “coupled,” or “joined” to a second component, it may include a case in which the first component is directly connected, coupled, or joined to the second component, but also a case in which the first component is “connected,” “coupled,” or “joined” to the second component by other components present between the first component and the second component.

In addition, when a certain component is described as being formed or disposed on “on (above)” or “below (under)” another component, the terms “on (above)” or “below (under)” may include not only a case in which two components are in direct contact with each other, but also a case in which one or more other components are formed or disposed between the two components. In addition, when described as “on (above) or below (under),” it may include the meaning of not only an upward direction but also a downward direction based on one component.

An automation level of an autonomous driving vehicle may be classified as follows, according to the American Society of Automotive Engineers (SAE). At autonomous driving level 0, the SAE classification standard may correspond to “no automation,” in which an autonomous driving system is temporarily involved in emergency situations (e.g., automatic emergency braking) and/or provides warnings only (e.g., blind spot warning, lane departure warning, etc.), and a driver is expected to operate the vehicle. At autonomous driving level 1, the SAE classification standard may correspond to “driver assistance,” in which the system performs some driving functions (e.g., steering, acceleration, brake, lane centering, adaptive cruise control, etc.) while the driver operates the vehicle in a normal operation section, and the driver is expected to determine an operation state and/or timing of the system, perform other driving functions, and cope with (e.g., resolve) emergency situations. At autonomous driving level 2, the SAE classification standard may correspond to “partial automation,” in which the system performs steering, acceleration, and/or braking under the supervision of the driver, and the driver is expected to determine an operation state and/or timing of the system, perform other driving functions, and cope with (e.g., resolve) emergency situations. At autonomous driving level 3, the SAE classification standard may correspond to “conditional automation,” in which the system drives the vehicle (e.g., performs driving functions such as steering, acceleration, and/or braking) under limited conditions but transfer driving control to the driver when the required conditions are not met, and the driver is expected to determine an operation state and/or timing of the system, and take over control in emergency situations but do not otherwise operate the vehicle (e.g., steer, accelerate, and/or brake). At autonomous driving level 4, the SAE classification standard may correspond to “high automation,” in which the system performs all driving functions, and the driver is expected to take control of the vehicle only in emergency situations. At autonomous driving level 5, the SAE classification standard may correspond to “full automation,” in which the system performs full driving functions without any aid from the driver including in emergency situations, and the driver is not expected to perform any driving functions other than determining the operating state of the system. Although the present disclosure may apply the SAE classification standard for autonomous driving classification, other classification methods and/or algorithms may be used in one or more configurations described herein.

One or more features associated with autonomous driving control may be activated based on configured autonomous driving control setting(s) (e.g., based on at least one of: an autonomous driving classification, a selection of an autonomous driving level for a vehicle, etc.). Based on one or more features (e.g., features of updating a security configuration of a vehicle's security system with a latest version) described herein, an operation of the vehicle may be controlled. The vehicle control may include various operational controls associated with the vehicle (e.g., autonomous driving control, sensor control, braking control, braking time control, acceleration control, acceleration change rate control, alarm timing control, forward collision warning time control, etc.).

One or more auxiliary devices (e.g., engine brake, exhaust brake, hydraulic retarder, electric retarder, regenerative brake, etc.) may also be controlled, for example, based on one or more features (e.g., features of updating a security configuration of a vehicle's security system with a latest version) described herein.

One or more communication devices (e.g., a modem, a network adapter, a radio transceiver, an antenna, etc., that is capable of communicating via one or more wired or wireless communication protocols, such as Ethernet, Wi-Fi, near-field communication (NFC), Bluetooth, Long-Term Evolution (LTE), 5G New Radio (NR), vehicle-to-everything (V2X), etc.) may also be controlled, for example, based on one or more features (e.g., features of updating a security configuration of a vehicle's security system with a latest version) described herein.

Minimum risk maneuver (MRM) operation(s) may also be controlled, for example, based on one or more features (e.g., features of updating a security configuration of a vehicle's security system with a latest version) described herein. A minimal risk maneuvering operation (e.g., a minimal risk maneuver, a minimum risk maneuver) may be a maneuvering operation of a vehicle to minimize (e.g., reduce) a risk of collision with surrounding vehicles in order to reach a lowered (e.g., minimum) risk state. A minimal risk maneuver may be an operation that may be activated during autonomous driving of the vehicle when a driver is unable to respond to a request to intervene. During the minimal risk maneuver, one or more processors of the vehicle may control a driving operation of the vehicle for a set period of time.

Biased driving operation(s) may also be controlled, for example, based on one or more features (e.g., features of updating a security configuration of a vehicle's security system with a latest version) described herein. A driving control apparatus may perform a biased driving control. To perform a biased driving, the driving control apparatus may control the vehicle to drive in a lane by maintaining a lateral distance between the position of the center of the vehicle and the center of the lane. For example, the driving control apparatus may control the vehicle to stay in the lane but not in the center of the lane. The driving control apparatus may identify or determine a biased target lateral distance for biased driving control. For example, a biased target lateral distance may comprise an intentionally adjusted lateral distance that a vehicle may aim to maintain from a reference point, such as the center of a lane or another vehicle, during maneuvers such as lane changes. This adjustment may be made to improve the vehicle's stability, safety, and/or performance under varying driving conditions, etc. For example, during a lane change, the driving control system may bias the lateral distance to keep a safer gap from adjacent vehicles, considering factors such as the vehicle's speed, road conditions, and/or the presence of obstacles, etc.

One or more sensors (e.g., IMU sensors, camera, LIDAR, RADAR, blind spot monitoring sensor, line departure warning sensor, parking sensor, light sensor, rain sensor, traction control sensor, anti-lock braking system sensor, tire pressure monitoring sensor, seatbelt sensor, airbag sensor, fuel sensor, emission sensor, throttle position sensor, inverter, converter, motor controller, power distribution unit, high-voltage wiring and connectors, auxiliary power modules, charging interface, etc.) may also be controlled, for example, based on one or more features (e.g., features of updating a security configuration of a vehicle's security system with a latest version) described herein. An operation control for autonomous driving of the vehicle may include various driving control of the vehicle by the vehicle control device (e.g., acceleration, deceleration, steering control, gear shifting control, braking system control, traction control, stability control, cruise control, lane keeping assist control, collision avoidance system control, emergency brake assistance control, traffic sign recognition control, adaptive headlight control, etc.).

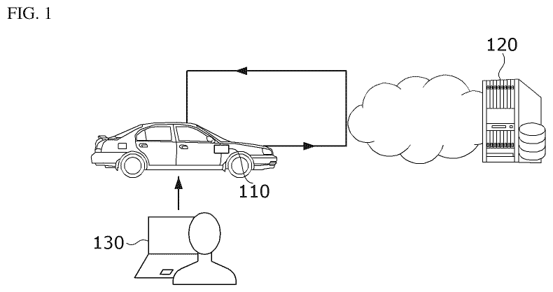

FIG. 1 shows an example in which an intrusion may occur due to a device outside a vehicle in an entire system, in which an in-vehicle electronic device (e.g., an electronic control circuit, a telematics control circuit, or an infotainment system, etc.) capable of detecting and preventing an intrusion is connected to a server (e.g., a remote computing server such as a cloud-based security server or a vehicle manufacturer's backend system, etc.), according to one example of the present disclosure.

Referring to FIG. 1, an in-vehicle electronic device 110 may be connected to a remote computing server (e.g., a server 120) through a communication network (e.g., cellular, Wi-Fi, V2X, or satellite, etc.). The in-vehicle electronic device 110 may be connected to the server 120 through wireless (e.g., Wi-Fi, Bluetooth, Cellular Networks, GPS, Satellite Communication, Zigbee, NFC, RFID, etc.) communication but is not limited thereto. For example, the in-vehicle electronic device 110 may be connected to the server 120 through wired communication (e.g., Ethernet, USB, HDMI, Coaxial Cables, etc.). In addition, although FIG. 1 illustrates the in-vehicle electronic device 110 directly connected to the server 120, the in-vehicle electronic device 110 may be indirectly connected through another electronic device (e.g., an intermediary network node such as a cloud gateway, an edge computing device, or a local router, etc.).

According to one example, the server 120 may be one of an intrusion detection server, an intrusion prevention server, or an integrated cybersecurity management server (e.g., an intrusion detection and prevention server). The server 120 may be operated by vehicle manufacturers but is not limited thereto. For example, the server 120 may be operated by companies (e.g., fleet management companies) that provide related services. The server 120 may store a security configuration such as an intrusion detection policy (e.g., intrusion detection configurations, security policies/rules, anomaly detection rules, packet filtering criteria, or access control settings, etc.) for detecting and/or preventing an intrusion into the vehicle. The server 120 may store a plurality of intrusion detection policies, and the intrusion detection policy may be determined considering at least one of vehicle type, vehicle specifications (e.g., hardware or software specifications), vehicle location (e.g., city, state/province, country, region, street address, intersection, landmark, point of interest, GPS coordinates, Geofence, distance/direction, route segment, parking spot, garage, warehouse, onboard a ship/train, etc.), cybersecurity threat level, or network connectivity state, etc.

According to one example, the intrusion may be caused by an external device (e.g., a device 130 outside the vehicle). An intrusion into the in-vehicle network (e.g., communication network) may be caused in a wireless or wired manner. For example, a malicious Wi-Fi hotspot, unauthorized Bluetooth connection, compromised telematics unit, or a hacked USB port, etc. could introduce a cybersecurity threat. According to one example, an intrusion may also be caused by a compromised server or cloud service, but since it is out of the scope of the present disclosure, description thereof will be omitted here.

According to one example, the vehicle may include a plurality of electronic devices or electronic control units (e.g., ECUs of vehicles, network gateways, sensors, or actuators, etc.), at least one of which may perform a function for detecting and/or preventing an intrusion into the in-vehicle network. For example, an electronic device (e.g., in-vehicle electronic device 110) that operates as an in-vehicle gateway (e.g., security gateway) may perform a function (e.g., analyzing network traffic patterns, detecting abnormal data packets, and enforcing access control rules, etc.) for detecting and/or preventing an intrusion into the in-vehicle network.

Throughout the present disclosure, references to components, units, or modules generally refer to items that logically can be grouped together to perform a function or group of related functions. Like reference numerals are generally intended to refer to the same or similar components. Components, units, and modules may be implemented in software, hardware or a combination of software and hardware. The components, units, modules, and/or functions described above may be implemented and/or performed by one or more processors. For examples, the components, units, and/or modules may include processor(s), microprocessor(s), graphics processing unit(s), logic circuit(s), dedicated circuit(s), application-specific integrated circuit(s), programmable array logic, field-programmable gate array(s), controller(s), microcontroller(s), and/or other suitable hardware. The components, units, and/or modules may also include software control module(s) implemented with a processor or logic circuitry for example. The components, units, and/or modules may include or otherwise be able to access memory such as, for example, one or more non-transitory computer-readable storage media, such as random-access memory, read-only memory, electrically erasable programmable read-only memory, erasable programmable read-only memory, flash/other memory device(s), data registrar(s), database(s), and/or other suitable hardware. One or more storage type media may include any or all of the tangible memory of computers, processors, or the like, or associated modules thereof, such as various semiconductor memories, tape drives, disk drives and the like, which may provide non-transitory storage at any time for software programming.

When a vehicle system or an ignition (IG) is turned on, the vehicle may execute a cybersecurity management application (e.g., a program or software such as an intrusion detection service, a firewall application, or a threat intelligence module, etc.) for detecting and/or preventing an intrusion. In one example, the program or software for detecting and/or preventing an intrusion may load an intrusion detection policy when first executed and may not load or reload the intrusion detection policy while the program or software is being executed. The intrusion detection policy may be decrypted when loaded and stored in an encrypted manner (e.g., using various encryption techniques such as AES-256, RSA, or ECC, etc.) or in a security area when stored. Thereafter, when a vehicle system or the IG is turned off, the program or software (e.g., cybersecurity management application) for detecting and/or preventing an intrusion may also be turned off. In one example, the vehicle may store or log a network security events (e.g., intrusion-related log such as detected intrusions, blocked connections, firewall rule violations, or authentication failures, etc.) and transmit the stored log to a server (e.g., a remote computing server) as needed or requested.

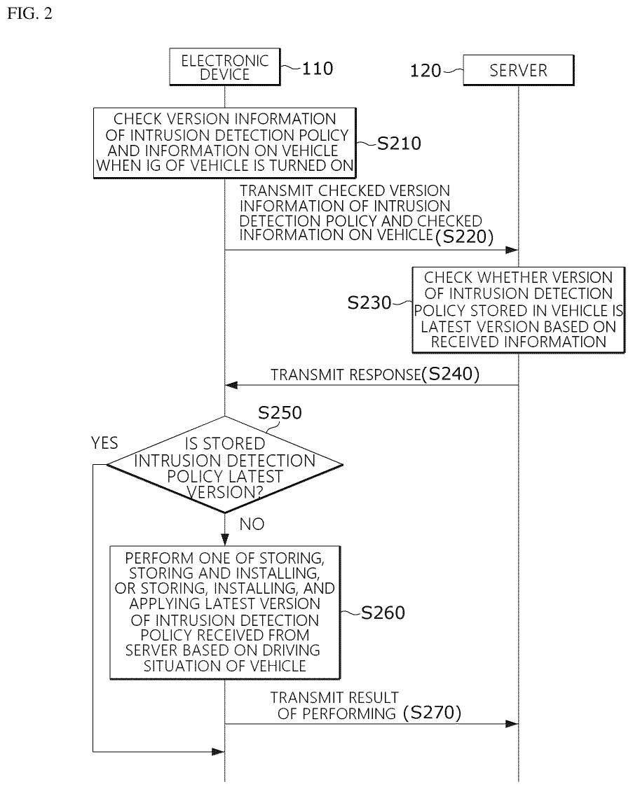

FIG. 2 shows an example of updating an intrusion detection policy by the in-vehicle electronic device through communication with the server (e.g., a remote computing server) according to one example of the present disclosure.

Referring to FIG. 2, the in-vehicle electronic device 110 may check or determine version information (e.g., software version number, policy version number, firmware version number, or a combination of software, policy, and firmware version numbers, date-based version number, timestamp-based version number, alphanumeric version number, metadata comprising version number, release date, author, description, changelog, update history, last update timestamp, system integrity check, etc.) of the intrusion detection policy stored in the vehicle and information on the vehicle when the IG of the vehicle is turned on (S210). The version information of the intrusion detection policy and the information on the vehicle may be stored in an internal memory of the electronic device 110 or a separate storage device. The electronic device 110 may check the version information of the intrusion detection policy and the information on the vehicle (e.g., operational information such as engine speed (RPM), temperature, oil pressure, fuel level, diagnostic trouble codes, odometer reading, trip meter reading, vehicle speed, gear position, acceleration, braking force, steering angle, wheel speed, tire pressure, suspension status, battery voltage, road conditions, current time/date, navigation information, route guidance, estimated time of arrival, distance to destination, status of lights, adaptive cruise control information, blind spot monitoring, driver attention monitoring, etc.) from the internal memory or the separate storage device when the IG of the vehicle is turned on.

The electronic device 110 (e.g., in-vehicle computing device) may transmit the checked version information of the intrusion detection policy and the checked information on the vehicle to the server 120 (S220). The version information of the intrusion detection policy may include information on at least one of the number of times the intrusion detection policy is changed, the time of change (e.g., the last update timestamp), and a host (e.g., an entity responsible for the update) who changes the intrusion detection policy. In addition, the information on the vehicle may include at least one of information on a driving situation (e.g., road conditions, vehicle speed, gear position, engine RPM, throttle position, road signs, presence of other vehicles in adjacent lanes, presence of pedestrians, etc.) of the vehicle, information on the vehicle's current driving state information (e.g., gear state such as neutral, reverse, or drive, etc.), information on a model (e.g., a model number) or specifications (e.g., manufacturing year, onboard processing capabilities, or communication protocols supported, etc.) of the vehicle, information on a service (e.g., connectivity/telematics service such as Wi-Fi Hotspot, remote vehicle access, Over-the-Air(OTA) updates, emergency assistance, stolen vehicle tracking, Infotainment/Entertainment service such as Satellite Radio, navigation updates, Maintenance/Warranty service such as pre-paid maintenance plan or extended warranty, real-time security monitoring service, etc.) to which the vehicle is subscribed, or information (e.g., distance and direction, distance to destination, estimated time of arrival, along a route, parking spot, inside a building/structure, on a ship/train/plane, track of past locations, time spent at locations, etc.) on a location of the vehicle. For example, the information on the driving situation of the vehicle may include at least one of on/off states of the IG of the vehicle and a gear state of the vehicle, and the information on the model or specifications of the vehicle may include at least one of information on a model number, a manufacturing date, and specifications of the vehicle. The information about the service to which the vehicle is subscribed may include at least one of information on whether the vehicle is subscribed to a service related to intrusion detection and/or protection, and information on the type of the service to which the vehicle is subscribed, and the information on the location of the vehicle may include at least one of information on a location (e.g., country, state/province, city, region, GPS coordinate, street address, intersection, landmark, neighboring/district, etc.) at which the vehicle was manufactured and a current location (e.g., country, state/province, city, region, GPS coordinate, street address, intersection, landmark, neighboring/district, etc.) of the vehicle.

According to one example, the electronic device 110 may add or attach a digital signature to the checked version information of the verified intrusion detection policy and the checked information on the vehicle, encrypt the information, and transmit the encrypted information to the server 120.

Based on the received information, the server 120 may verify whether the version of the intrusion detection policy stored in the vehicle is the latest version (S230). Alternatively, based on the received information, the server 120 may determine whether the version of the intrusion detection policy stored in the vehicle is appropriate. For example, the server 120 may check whether the version of the intrusion detection policy transmitted by the electronic device is appropriate considering at least one of the model or specifications of the vehicle, the service to which the vehicle is subscribed, or the location of the vehicle (e.g., regional security compliance policies).

The server 120 may transmit a response to the checked result to the electronic device 110 (S240). For example, when the version information included in the information transmitted by the electronic device 110 is the latest version, an acknowledgment (ack) may be transmitted as a response. Alternatively, when the version information included in the information transmitted by the electronic device 110 is not the latest, a negative acknowledgement (nack) or/and the intrusion detection policy of the latest version may be transmitted as a response. When the version information included in the information transmitted by the electronic device 110 is not the latest version, the server 120 may transmit the intrusion detection policy of the latest version as a response, or when the electronic device 110 requests the intrusion detection policy of the latest version (e.g., if the received digital signature is broken, for example, the digital signature verification fails due to a corrupted or tampered configuration, etc.), the server 120 may transmit the intrusion detection policy of the latest version.

According to one example, when transmitting the intrusion detection policy of the latest version to the electronic device 110, the server 120 may add a digital signature to the intrusion detection policy of the latest version and encrypt (e.g., TLS, AES encryption, or RSA digital signatures, etc.) and transmit the encrypted intrusion detection policy of the latest version like the electronic device 110.

The electronic device 110 may check whether the intrusion detection policy stored is the latest version based on the received response (S250). When checking that the stored intrusion detection policy is the latest version, the electronic device 110 may no longer proceed with the subsequent procedure (e.g., terminate the update process and continue operating with the existing policy).

When checking that the stored intrusion detection policy is not the latest version, the electronic device 110 may perform, based on the operational status (e.g., the driving situation) of the vehicle (S260), one of (1) storing the latest version of the intrusion detection policy for future installation, (2) storing and installing the latest version of the intrusion detection policy, or (3) storing, installing, and applying the latest version of the intrusion detection policy received from the server 120. When receiving the intrusion detection policy of the latest version from the server 120, the electronic device 110 may first temporarily store the intrusion detection policy of the latest version. Thereafter, when installing the intrusion detection policy of the latest version, the electronic device may update the previous version of the intrusion detection policy to the intrusion detection policy of the latest version.

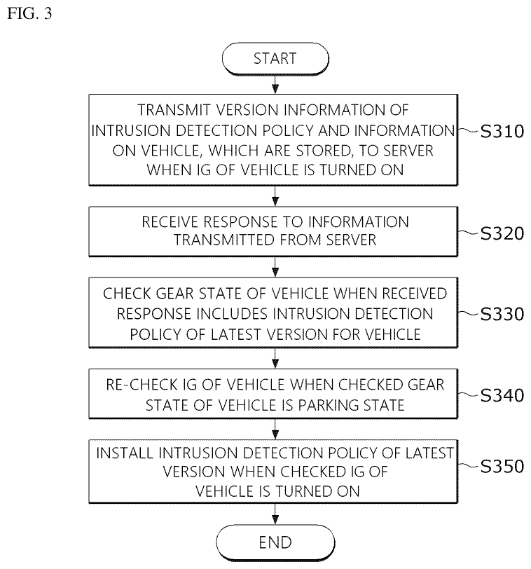

A specific procedure of storing, storing and installing, or storing, installing, and applying the intrusion detection policy of the latest version received from the server 120 based on the driving situation of the vehicle by the electronic device 110 is described in detail with reference to FIG. 3.

The electronic device 110 may transmit a status update (e.g., the result of storing, storing and installing, or storing, installing, and applying the intrusion detection policy of the latest version received from the server 120) to the server 120 (S270). For example, the status update may comprise confirmation of successful deployment of the latest version, error logs if the update process failed, or system integrity verification results. etc.

FIG. 3 shows an example of updating an intrusion detection policy considering a driving situation of a vehicle by the in-vehicle electronic device according to one example of the present disclosure.

Referring to FIG. 3, when the IG of the vehicle is turned on, the electronic device may transmit the version information of the intrusion detection policy stored in the vehicle and the information (e.g., vehicle operational information) on the vehicle to the server (S310). When the IG of the vehicle is turned on, power may be supplied to at least some of the plurality of electronic control units (e.g., engine control circuit, transmission control circuit, brake control system, or infotainment circuit, etc.) included in the vehicle. In the present disclosure, the power may be supplied to the electronic device for updating the intrusion detection policy considering the driving situation of the vehicle. According to one example, the electronic device for updating the intrusion detection policy considering the driving situation (e.g., the IG on/off state, gear state such as park, neutral, reverse, or drive, etc.) of the vehicle may be an in-vehicle gateway.

The intrusion detection policy may be stored in a memory in the electronic device or stored in a separate storage device. The electronic device may check the version of the intrusion detection policy in the memory or in the separate storage device (e.g., hardware security module (HSM), trusted platform module (TPM), or encrypted flash memory, etc.) and transmit the version to the server. In addition, the electronic device may transmit the information on the vehicle to the server. The information on the vehicle may include, for example, at least one of the information (e.g., IG on/off state, gear position, or vehicle motion status, etc.) on the driving situation of the vehicle, the information (e.g., ECU models, firmware versions, network protocols supported, or computing resources available, etc.) on the model or specifications of the vehicle, the information (e.g., intrusion detection monitoring, over-the-air (OTA) security updates, or real-time anomaly detection services, etc.) on the service to which the vehicle is subscribed, and the information (e.g., manufacturing region, real-time GPS location, or country-specific security compliance requirements, etc.) on the location of the vehicle. Since the information on the driving situation of the vehicle may include at least one of the on/off states of the IG of the vehicle and the gear state (e.g., Park, Neutral, Reverse, or Drive, etc.) of the vehicle, when the electronic device transmits the information on the driving situation of the vehicle to the server, the server may predict or determine whether the intrusion detection policy of the latest version transmitted by the server may be immediately installed and applied (or deployed and activated). In addition, when the electronic device transmits the information on the model or specifications of the vehicle and/or the information on the service to which the vehicle is being driven, the server may check or determine the intrusion detection policy of the latest version corresponding to the vehicle that has transmitted the information (e.g., determining a customized intrusion detection policy based on the vehicle's profile). Since intrusion detection policy may vary by country or region, the electronic device may also transmit the information on the location of the vehicle to the server.

In one example, the vehicle may be a vehicle that subscribes to a service related to the intrusion detection policy, and the server may be an intrusion detection server, an intrusion prevention server, or an integrated cybersecurity management platform (e.g., an intrusion detection and prevention server) of the vehicle. The server may be operated by vehicle manufacturers but may also be operated by companies (e.g., third-party cybersecurity providers or fleet manamgement service operators, etc.) that provide services related to the intrusion detection policy.

The electronic device may receive a response to the information transmitted from the server (S320). For example, when the version information included in the information transmitted by the electronic device is the latest version, the server may transmit an acknowledgement (ack) as a response and otherwise, may transmit a negative acknowledgement (nack) or/and the intrusion detection policy of the latest version as a response. When the intrusion detection policy of the latest version is transmitted, a digital signature may be added, and the intrusion detection policy of the latest version may be transmitted in an encrypted manner. When receiving the intrusion detection policy of the latest version, the electronic device may temporarily store the intrusion detection policy of the latest version in a buffer, etc. Additionally, if the received intrusion detection policy of the latest version is corrupted (e.g., digital signature verification fails, unauthorized modification, etc.), the electronic device may request a retransmission of the latest version.

When the received response includes the intrusion detection policy of the latest version for a vehicle, the electronic device may check a gear state of the vehicle (S330). A gear of the vehicle may be one selected from park (P), neutral (N), reverse (R), and drive (D), and in the present disclosure, neutral (N), reverse (R), and drive (D) may be considered as a driving state or a stopping state, and park (P) may be considered as a parking state.

Meanwhile, when the received response is a simple ack or the received response does not include the intrusion detection policy of the latest version for a vehicle, the electronic device may determine that the intrusion detection policy stored in the vehicle is already the latest version and may not proceed with the subsequent procedure.

If the checked gear state of the vehicle is the parking state, the electronic device may re-check the IG of the vehicle (S340).

If the checked IG of the vehicle is turned on, the electronic device may install the intrusion detection policy of the latest version (S350). Since the gear state of the vehicle is the parking state, it is considered safe for the electronic device to proceed to install the intrusion detection policy of the latest version. According to one example, the installation of the intrusion detection policy may be a task of updating the intrusion detection policy of the latest version, which is temporarily stored, in the memory or the separate storage device. For example, the task of updating may involve writing the new policy into memory or secure storage, verifying the digital signature and data integrity, and activating the new policy during the next system startup.

If the IG of the vehicle that has been re-checked is turned off, the electronic device may install and apply the intrusion detection policy of the latest version. According to one example, if the gear state of the vehicle is the parking state and the IG of the vehicle is changed to off by a user, the electronic device may install and apply the intrusion detection policy of the latest version and then turn off the IG of the vehicle.

According to one example, when installing or applying the intrusion detection policy of the latest version, the electronic device may transmit information related thereto (e.g., status report, for example, including confirmation of successful deployment, verification of correct application, error logs in case of failures, a timestamp indicating the update completion time, etc.) to the server. For example, the electronic device may transmit information on whether the installation of the intrusion detection policy of the latest version is performed normally or successfully, whether the intrusion detection policy of the latest version is applied normally or successfully, when the intrusion detection policy of the latest version is installed or applied, etc., to the server.

According to the present disclosure, if the checked gear state of the vehicle is not the parking state but a stationary state (e.g., neutral or reverse) or a driving state, the electronic device may not install and/or apply the intrusion detection policy of the latest version, thereby considering the safety of a vehicle and a passenger. That is, even if a problem occurs when the intrusion detection policy of the latest version is installed and/or applied, the safety of a vehicle and a passenger may not be affected because the vehicle is not in the driving state or the stationary state.

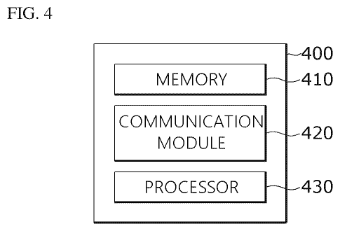

FIG. 4 shows an example of an electronic device that updates the intrusion detection policy considering the driving situation of the vehicle. The electronic device may be an electronic device 400 (e.g., in-vehicle electronic device 110), which is included in the vehicle, according to one example of the present disclosure.

Referring to FIG. 4, the electronic device 400 (hereinafter referred to as an “electronic device”) that updates the intrusion detection policy considering the driving situation of the vehicle may include a memory 410, a communication module 420 (e.g., transceiver), and a processor 430. For example, the processor 430 (e.g., circuit, circuitry, application-specific integrated circuits (ASICs)) may be an automotive microcontroller, a system-on-chip, or a dedicated security processor. It may also be a general-purpose embedded processor or a custom cybersecurity processor.

According to one example, the electronic device 400 may be an in-vehicle gateway, a component of the gateway, or an electronic device connected to the gateway. For example, the electronic device 400 may comprise a telematics unit, firewall module, or vehicle security processor, etc.

The memory 410 may store various programs, software, and data (e.g., system logs) required for operating the electronic device 400. For example, various programs or software required for operating the electronic device 400 may be programs or software (e.g., cybersecurity applications) for detecting and/or preventing an intrusion into a vehicle. In addition, the memory 410 may store commands, configuration files, or system instructions for driving the processor 430. According to one example, the memory 410 may store an intrusion detection policy (e.g., security rules, anomaly detection thresholds, access control lists, or packet filtering parameters, etc.). The intrusion detection policy may be stored in a secure area in the memory 410 or stored in an encrypted manner (e.g., AES-256, RSA encryption, or hardware-based trusted execution environments, etc.). The memory 410 may store one or more intrusion detection policy. In addition, the memory 410 may store a log (e.g., security events, intrusion attempts, and system updates, etc.) collected by the processor 430. The programs and data stored in the memory 410 may be deleted or updated. For example, the stored programs and data may be periodically updated or deleted based on server instructions or automated security policies.

The communication module 420 (e.g., circuitry implementing a receiver and/or a transmitter) may allow the electronic device 400 to transmit and receive data with other in-vehicle electronic devices and/or devices outside the vehicle. Specifically, the communication module 420 may be connected to the server (e.g., a cloud-based cybersecurity platform, manufacturer's backend system, or fleet management server, etc.), receive the intrusion detection policy of the latest version from the server, and transmit the version of the intrusion detection policy that is currently stored to the server in order to receive the intrusion detection policy of the latest version. For example, the version information of the intrusion detection policy may include information on at least one of the number of times the intrusion detection policy is changed, the time of change (e.g., the last modification timestamp), and a host (e.g., manufacturer, cybersecurity service provider, or fleet operator, etc.) who changes the intrusion detection policy. In addition, the communication module 420 may also transmit information on the vehicle to the server. For example, the information on the vehicle may include at least one of the information on the driving situation (e.g., ignition status, gear position, vehicle speed, or network connectivity state, etc.) of the vehicle, the information (e.g., ECU model, firmware version, installed security patches, or supported communication protocols, etc.) on the model or specifications of the vehicle, the information (e.g., whether the vehicle is enrolled in an intrusion detection monitoring program or real-time security updates, etc.) on the service to which the vehicle is subscribed, and the information (e.g., current GPS coordinates, region-specific cybersecurity regulations, or compliance settings, etc.) on the location of the vehicle.

The processor 430 may transmit the version information of the intrusion detection policy and the information (e.g., vehicle-specific data) on the vehicle, which are stored, to the server when the IG of the vehicle is turned on. The version information of the intrusion detection policy and the information on the vehicle may be stored in the memory 410 but are not limited thereto. According to one example, if the IG of the vehicle is turned on, power may also be supplied to the electronic device 400, and in this case, if power is supplied to the electronic device 400, the electronic device 400 may transmit the version information of the intrusion detection policy and the information on the vehicle, which are stored, to the server (e.g., a remote computing server).

The processor 430 may receive a response from the server. The server may determine whether the version of the stored intrusion detection policy by the electronic device 400 is the latest version and transmit a response. The response from the server may be an ack or nack. Specifically, if the response from the server is an ack, it may indicate that the version of the intrusion detection policy stored in the vehicle is the latest version. Alternatively, if the response from the server is the ack, it may indicate that the information transmitted by the processor 430 was transmitted properly. In this case, the server may transmit whether the version of the intrusion detection policy stored in the vehicle is the latest version and, if it is not the latest version, the intrusion detection policy of the latest version as a separate message. As another example, the server may transmit the nack when the version of the intrusion detection policy stored in the vehicle is not the latest version. In this case, the intrusion detection policy of the latest version may be transmitted together with or separately from the nack. Alternatively, or additionally, the server may transmit a response indicating that an update is required if the server detects an outdated intrusion detection policy. Further, if the received policy is digitally signed and encrypted, the processor 430 may verify authenticity of the digital signature, the integrity of the received policy (e.g., performing hash function), or the compatibility of the received policy with the vehicle.

If the version of the intrusion detection policy stored in the vehicle is the latest version, the processor 430 may not perform the following operations involved in an update procedure. However, If the version of the intrusion detection policy stored in the vehicle is not the latest version, the processor 430 may check the gear state of the vehicle for update. As described above, the gear of the vehicle may be one selected from park (P), neutral (N), reverse (R), and drive (D), and in the present disclosure, neutral (N), reverse (R), and drive (D) may be considered as a driving state or a stationary state, and park (P) may be considered as a parking state.

The processor 430 may re-check the IG of the vehicle if the checked gear state of the vehicle is the parking state (P). If the checked gear state of the vehicle is the driving state or the stationary state, that is, one of neutral (N), reverse (R), and drive (D), the processor 430 may no longer perform the update procedure of the intrusion detection policy for the safety of a vehicle and a passenger. In this case, the processor 430 may temporarily store the intrusion detection policy of the latest version in the memory or the buffer.

If the checked gear state of the vehicle is the parking state (P) and the checked IG of the vehicle is turned on, the processor 430 may install the intrusion detection policy of the latest version, and if the checked IG of the vehicle is turned off, the processor 430 may install and apply the intrusion detection policy of the latest version. Specifically, if the checked IG of the vehicle is turned on, the processor 430 may update the intrusion detection policy of the latest version, which is temporarily stored, in the memory or the separate storage device. In addition, if the checked IG of the vehicle is turned off, the processor 430 may update the intrusion detection policy of the latest version, which is temporarily stored, in the memory or the separate storage device and apply the intrusion detection policy of the latest version.

If the processor 430 completes the installation or/and application of the intrusion detection policy of the latest version, the processor 430 may transmit information (e.g., status report) on the completed result to the server. The status report may include information about successful deployment confirmation, any errors encountered, digital validation results, or timestamp of update completion, etc. . . For example, the processor 430 may transmit information on whether the installation of the intrusion detection policy of the latest version is performed normally or successfully, whether the intrusion detection policy of the latest version is applied normally or successfully, when the intrusion detection policy of the latest version is installed or applied, etc., to the server.

The present disclosure is directed to providing a method of updating a new intrusion detection policy by a network intrusion detection and/or protection system inside a vehicle after the vehicle is released, and a device for performing the same.

In addition, the present disclosure is directed to providing a method of updating the latest version of an intrusion detection policy while considering safety of a vehicle and a passenger, and a device for performing the same.

In addition, objects of the present disclosure are not limited to the above objects, and other objects may be further present.

A method of updating an intrusion detection policy considering a driving situation of a vehicle according to an example of the present disclosure includes transmitting version information of an intrusion detection policy and information on the vehicle, which are stored, to a server when an ignition (IG) of the vehicle is turned on, receiving a response to the transmitted information from the server, checking a gear state of the vehicle when the received response includes an intrusion detection policy of a latest version for the vehicle, checking the IG of the vehicle when the checked gear state of the vehicle is a parking state, and installing the intrusion detection policy of the latest version when the checked IG of the vehicle is turned on.

The information on the vehicle may include information on a current driving situation of the vehicle.

The information on the current driving situation of the vehicle may include at least one of on/off states of the IG of the vehicle and the gear state of the vehicle.

The method may further include detecting an intrusion into the vehicle using an intrusion detection policy of a version transmitted to the server.

The method may further include applying the installed intrusion detection policy of the latest version when the checked gear state of the vehicle is the parking state and the checked IG of the vehicle is turned off.

The method may further include deleting an intrusion detection policy of a version transmitted to the server.

The method may further include downloading the intrusion detection policy of the latest version included in the received response when the checked gear state of the vehicle is a driving state.

The method may further include detecting an intrusion into the vehicle using an intrusion detection policy of a version transmitted to the server.

The intrusion detection policy of the latest version included in the received response may include a digital signature and may be encrypted.

An electronic device for updating an intrusion detection policy considering a driving situation of a vehicle includes a memory, a communication module, and a processor configured to transmit version information of the intrusion detection policy and information on the vehicle, which are stored, to a server when an ignition (IG) of the vehicle is turned on, receive a response to the transmitted information from the server, check a gear state of the vehicle when the received response includes an intrusion detection policy of a latest version for the vehicle, check the IG of the vehicle when the checked gear state of the vehicle is a parking state, and install the intrusion detection policy of the latest version when the checked IG of the vehicle is turned on. The information on the vehicle may include information on a current driving situation of the vehicle.

The information on the current driving situation of the vehicle may include at least one of on/off states of the IG of the vehicle and the gear state of the vehicle.

The processor may detect an intrusion into the vehicle using an intrusion detection policy of a version transmitted to the server.

The processor may apply the installed intrusion detection policy of the latest version when the checked gear state of the vehicle is the parking state and the checked IG of the vehicle is turned off.

The processor may delete an intrusion detection policy of a version transmitted to the server.

The processor may download the intrusion detection policy of the latest version included in the received response when the checked gear state of the vehicle is a driving state.

The processor may detect an intrusion into the vehicle using an intrusion detection policy of a version transmitted to the server.

The intrusion detection policy of the latest version included in the received response may include a digital signature and may be encrypted.

According to examples of the present disclosure, it is possible to update an intrusion detection policy by determining a driving situation of a vehicle in order to consider safety of a vehicle and a passenger.

In addition, according to the examples of the present disclosure, even when new threat is found after the vehicle is released, it is possible to update the intrusion detection policy capable of detecting the new threat inside the vehicle.

In addition, according to the examples of the present disclosure, even when the latest intrusion detection policy is downloaded from a server, the latest intrusion detection policy cannot be installed or applied while the vehicle drives or stops.

The effects obtainable from the present disclosure are not limited to the above-described effects, and other effects that are not mentioned will be able to be clearly understood by those skilled in the art to which the present disclosure pertains from the following description.

Although examples have been mainly described above, these are only illustrative and do not limit the present disclosure, and those skilled in the art to which the present disclosure pertains can know that various modifications and applications not exemplified above are possible without departing from the essential characteristics of the examples. For example, each component specifically shown in the examples may be implemented by modification. In addition, differences related to these modifications and applications should be construed as being included in the scope of the present disclosure defined in the appended claims.

What is claimed:

1. A method performed by an apparatus of a vehicle, the method comprising:
transmitting, based on a power state of the vehicle being turned on, version information of an intrusion detection policy for the vehicle and vehicle information of the vehicle to a server, wherein the version information and the vehicle information are stored in at least one storage of the vehicle;
receiving, from the server, a response to the transmitting;
identifying, based on a latest version of the intrusion detection policy received via the response, a gear state of the vehicle;
determining, based on the gear state of the vehicle being a parking state, whether the power state of the vehicle is turned on;
installing, based on a determination that the power state of the vehicle is turned on, the latest version of the intrusion detection policy on the vehicle; and
controlling, based on the latest version of the intrusion detection policy installed on the vehicle, operations of the vehicle.

2. The method of claim 1, wherein the vehicle information comprises information indicating a current driving state of the vehicle,
wherein the latest version of the intrusion detection policy comprises at least one intrusion detection policy associated with autonomous driving control of the vehicle, and
wherein the controlling the operations of the vehicle comprises controlling, based on the latest version of the intrusion detection policy installed on the vehicle, autonomous driving operations of the vehicle.

3. The method of claim 2, wherein the information indicating the current driving state of the vehicle comprises at least one of the power state of the vehicle or the gear state of the vehicle, and wherein the power state of the vehicle comprises an ignition (IG) state of the vehicle.

4. The method of claim 1, further comprising detecting an intrusion into the vehicle using an intrusion detection policy corresponding to a version indicated by the version information that has been transmitted to the server.

5. The method of claim 1, further comprising applying, based on the gear state of the vehicle being the parking state and the power state of the vehicle being turned off, the installed latest version of the intrusion detection policy to a security system of the vehicle,
wherein the controlling the operations of the vehicle comprises: after the applying the installed latest version of the intrusion detection policy to the security system of the vehicle, controlling, based on the applied latest version of the intrusion detection policy, the operations of the vehicle.

6. The method of claim 5, further comprising deleting an intrusion detection policy corresponding to a version indicated by the version information that has been transmitted to the server.

7. The method of claim 1, further comprising downloading, based on the gear state of the vehicle being a driving state, the latest version of the intrusion detection policy, wherein the latest version of the intrusion detection policy is included in the received response.

8. The method of claim 7, further comprising detecting an intrusion into the vehicle using an intrusion detection policy corresponding to a version indicated by the version information that has been transmitted to the server.

9. The method of claim 1, wherein the latest version of the intrusion detection policy is encrypted and included in the received response, and wherein the latest version of the intrusion detection policy comprises a digital signature.

10. An electronic device of a vehicle, the electronic device comprising:
a processor;
a communication circuit; and
a memory storing at least one instruction that, when executed by the processor, is configured to cause the electronic device to:
transmit, via the communication circuit and based on a power state of the vehicle being turned on, version information of an intrusion detection policy for the vehicle and vehicle information of the vehicle to a server, wherein the version information and the vehicle information are stored in at least one storage of the vehicle,
receive, from the server via the communication circuit, a response to the transmission,
identify, based on a latest version of the intrusion detection policy received via the response, a gear state of the vehicle,
determine, based on the gear state of the vehicle being a parking state, whether the power state of the vehicle is turned on,
install, based on a determination that the power state of the vehicle is turned on, the latest version of the intrusion detection policy on the vehicle, and
control, based on the latest version of the intrusion detection policy installed on the vehicle, operations of the vehicle.

11. The electronic device of claim 10, wherein the vehicle information comprises information indicating a current driving state of the vehicle,
wherein the latest version of the intrusion detection policy comprises at least one intrusion detection policy associated with autonomous driving control of the vehicle, and
wherein the at least one instruction, when executed by the processor, is configured to cause the electronic device to control the operations of the vehicle by controlling, based on the latest version of the intrusion detection policy installed on the vehicle, autonomous driving operations of the vehicle.

12. The electronic device of claim 11, wherein the information indicating the current driving state of the vehicle comprises at least one of the power state of the vehicle or the gear state of the vehicle, and wherein the power state of the vehicle comprises an ignition (IG) state of the vehicle.

13. The electronic device of claim 10, wherein the at least one instruction, when executed by the processor, is further configured to cause the electronic device to detect an intrusion into the vehicle using an intrusion detection policy corresponding to a version indicated by the version information that has been transmitted to the server.

14. The electronic device of claim 10, wherein the at least one instruction, when executed by the processor, is further configured to cause the electronic device to apply, based on the gear state of the vehicle being the parking state and the power state of the vehicle being turned off, the installed latest version of the intrusion detection policy to a security system of the vehicle,
wherein the at least one instruction, when executed by the processor, is configured to cause the electronic device to control the operations of the vehicle by:
after the applying the installed latest version of the intrusion detection policy to the security system of the vehicle, controlling, based on the applied latest version of the intrusion detection policy, the operations of the vehicle.

15. The electronic device of claim 14, wherein the at least one instruction, when executed by the processor, is further configured to cause the electronic device to delete an intrusion detection policy corresponding to a version indicated by the version information that has been transmitted to the server.

16. The electronic device of claim 10, wherein the at least one instruction, when executed by the processor, is further configured to cause the electronic device to download, based on the gear state of the vehicle being a driving state, the latest version of the intrusion detection policy, wherein the latest version of the intrusion detection policy is included in the received response.

17. The electronic device of claim 16, wherein the at least one instruction, when executed by the processor, is further configured to cause the electronic device to detect an intrusion into the vehicle using an intrusion detection policy corresponding to a version indicated by the version information that has been transmitted to the server.

18. The electronic device of claim 10, wherein the latest version of the intrusion detection policy is encrypted and included in the received response, and wherein the latest version of the intrusion detection policy comprises a digital signature.

19. A method performed by an apparatus of a vehicle, the method comprising:
transmitting, via a wireless transceiver of the vehicle and based on a power state of the vehicle being turned on,
version information of a security policy of the vehicle, and
vehicle information of the vehicle;
receiving, via the wireless transceiver, a response to the transmitting, wherein the response comprises a latest version of the security policy;
determining, based on the latest version of the security policy being newer than a version indicated by the version information, a gear state of the vehicle;
storing, based on the gear state of the vehicle not being a parking state, the latest version of the security policy;
installing, the gear state being transitioned to the parking state, the latest version of the security policy on the vehicle; and
controlling, based on the latest version of the security policy installed on the vehicle, operations of the vehicle.

20. The method of claim 19, wherein the vehicle information comprises information indicating a current driving state of the vehicle,
wherein the latest version of the security policy comprises at least one security policy associated with autonomous driving control of the vehicle, and
wherein the controlling the operations of the vehicle comprises controlling, based on the latest version of the security policy installed on the vehicle, autonomous driving operations of the vehicle.
